(19) United States
(12) Patent Application Publication
(10) Pub. No.: US 2024/0010413 A1
(43) Pub. Date: Jan. 11, 2024

(54) BUFFER MATERIAL AND BUFFER MATERIAL STRUCTURE

(71) Applicant: SEIKO EPSON CORPORATION, Tokyo (JP)

(72) Inventors: Tomoaki NAKAMURA, Shiojiri (JP); Tetsuji FUJITA, Chino (JP); Jun TAKIZAWA, Chino (JP); Hisashi KOIKE, Suwa (JP)

(21) Appl. No.: 18/347,603

(22) Filed: Jul. 6, 2023

(30) Foreign Application Priority Data
Jul. 8, 2022 (JP) 2022-110252

(51) Int. Cl. B65D 81/113

(52) U.S. Cl. CPC B65D 81/113

(57) ABSTRACT

A buffer material includes four buffer members containing cellulose fibers and having rectangular plate shapes similar to each other, in which the cellulose fibers are oriented along a main surface of the buffer member, at least two buffer members among the four buffer members have two recess portions on one specific side, the buffer material is assembled by inserting the other buffer members into the recess portions of the buffer members, two buffer members among the four buffer members are spaced apart from each other and each have the main surfaces disposed along a YZ plane, and the other two buffer members are spaced apart from each other and each have the main surfaces disposed along an XZ plane, and an article is stored in a region surrounded by the four buffer members in the plan view.

The present application is based on, and claims priority from JP Application Serial Number 2022-110252, filed Jul. 8, 2022, the disclosure of which is hereby incorporated by reference herein in its entirety.

### BACKGROUND

### 1. Technical Field

The present disclosure relates to a buffer material and a buffer material structure.

### 2. Related Art

In the related art, a buffer material for storing an article, such as a fragile object, has been known. For example, JP-A-2009-280269 discloses a packing box including a box-shaped main body and a reinforcing member. In addition, JP-A-2013-170001 discloses five types of buffer materials for holding a liquid crystal television.

However, the packing box disclosed in JP-A-2009-280269 has a problem that labor is required for assembly, such as bending or fixing of the reinforcing member. In addition, the buffer material disclosed in JP-A-2013-170001 has a problem that the number of components is likely to be increased. That is, there has been a demand for a buffer material that has a simple configuration and is easily assembled.

### SUMMARY

According to an aspect of the present disclosure, a buffer material includes four buffer members containing cellulose fibers and having rectangular plate shapes similar to each other, in which the cellulose fibers are oriented along a main surface of the buffer member, at least two buffer members among the four buffer members have two recess portions on one specific side, the buffer material is assembled by inserting the other buffer members into the recess portions of the buffer members, two buffer members among the four buffer members are spaced apart from each other and each have the main surfaces disposed along a first plane, and the other two buffer members are spaced apart from each other and each have the main surfaces disposed along a second plane orthogonal to the first plane in a plan view, and an article is stored in a region surrounded by the four buffer members in the plan view.

According to another aspect of the present disclosure, a buffer material structure includes four buffer members containing cellulose fibers and having rectangular plate shapes similar to each other, in which the cellulose fibers are oriented along a main surface of the buffer member, the four buffer members have the same shape having two recess portions on one specific side, two buffer members among the four buffer members are spaced apart from each other and each have the main surface disposed along a first plane, and the other two buffer members are spaced apart from each other and each have the main surface disposed along a second plane orthogonal to the first plane in a plan view, the one specific side is disposed in a first direction in the two buffer members having the main surfaces disposed along the first plane, the one specific side is disposed in a second direction, which is a direction opposite to the first direction, in the two buffer members having the main surfaces disposed along the second plane, the four buffer members are assembled by fitting the recess portion disposed on the one specific side in the first direction and the recess portion disposed on the one specific side in the second direction together, and an article is stored in a region surrounded by the four buffer members in the plan view.

### BRIEF DESCRIPTION OF THE DRAWINGS

FIG. 1 is a perspective view showing a configuration of a sheet applied to a buffer member according to an embodiment.

FIG. 2 is a schematic diagram showing a configuration of a test piece as an example used for a compression test.

FIG. 3 is a schematic diagram showing a configuration of a test piece as a comparative example used for a compression test.

FIG. 4 is a schematic diagram showing the configuration of the test piece as the comparative example used for the compression test.

FIG. 5 is a graph showing a compression ratio-stress curve of each test piece.

FIG. 6 is a diagram showing an appearance of the buffer member.

FIG. 7 is a perspective view showing disposition of the buffer member in a buffer material.

FIG. 8 is a perspective view showing an appearance of the buffer material.

FIG. 9 is a perspective view showing a use form of the buffer material.

FIG. 10 is a schematic diagram showing a configuration of a sheet manufacturing apparatus.

### DESCRIPTION OF EXEMPLARY EMBODIMENTS

In the embodiments described below, a buffer member formed by reusing waste paper or the like, and a buffer material and a buffer material structure formed from the buffer member will be shown and described with reference to the drawings. In each of the following drawings, XYZ axes, which are coordinate axes orthogonal to each other, are attached as necessary, and a direction indicated by an arrow is defined as a + direction, and a direction opposite to the + direction is defined as a − direction.

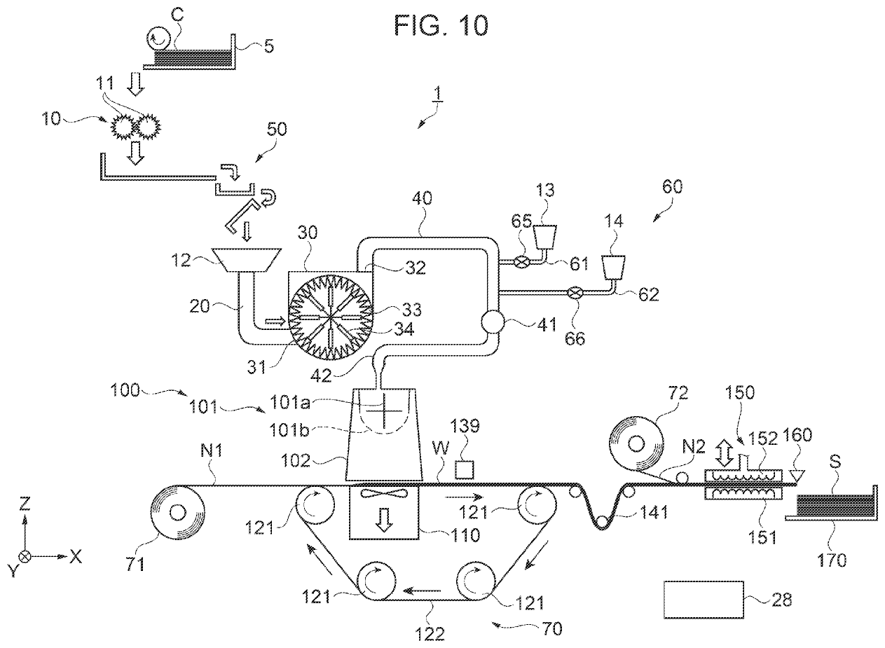

The directions of X, Y, and Z in FIG. 10 do not always match the directions of X, Y, and Z in the drawings other than FIG. 10. In addition, for convenience of illustration, a size of each member is different from an actual size.

### 1. Sheet

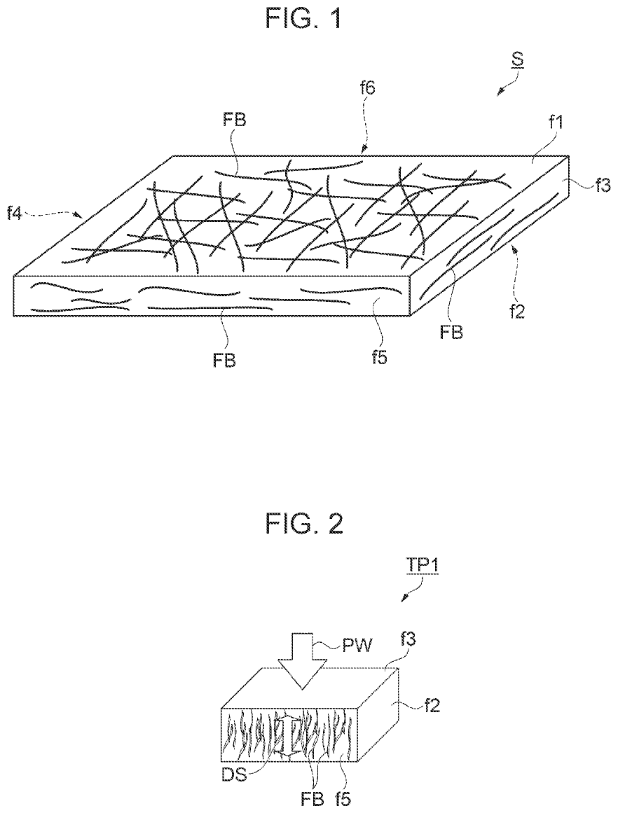

A buffer material 200 according to the present embodiment is formed by assembling a buffer member 201 produced from a sheet S. As shown in FIG. 1, the sheet S is a member having a rectangular plate shape. The sheet S has main surfaces f1 and f2 and side surfaces f3, f4, f5, and f6 facing each other. The side surfaces f3 and f4 face each other, and the side surfaces f5 and f6 face each other.

The sheet S contains a plurality of cellulose fibers FB. When the sheet S is viewed in a transmission view from a normal direction of the main surfaces f1 and f2, the plurality of cellulose fibers FB are not oriented in a specific direction. On the other hand, when the sheet S is viewed in the transmission view from a normal direction of the side surfaces f3 and f4 and a normal direction of the side surfaces f5 and f6, the plurality of cellulose fibers FB are oriented along the main surfaces f1 and f2. This orientation state is derived from a method of manufacturing the sheet S, which will be described below.

Due to the orientation state described above, the sheet S has low buffer performance with respect to an external force acting from the substantially normal direction of the main surfaces f1 and f2, and high buffer performance with respect to an external force acting from the substantially normal direction of the side surfaces f3 and f4 or the side surfaces f5 and f6.

Here, the buffer performance of the sheet S will be described by showing results of a compression test. FIG. 2 is a test piece TP1 as an example used in the compression test. The test piece TP1 is produced from the sheet S. In the test piece TP1, an orientation direction DS of the cellulose fibers FB is along the main surface f2 and is also along the main surface f1 (not shown). A compression force PW, which is the external force, is applied to the test piece TP1 from the normal direction of the side surface f3 in the compression test.

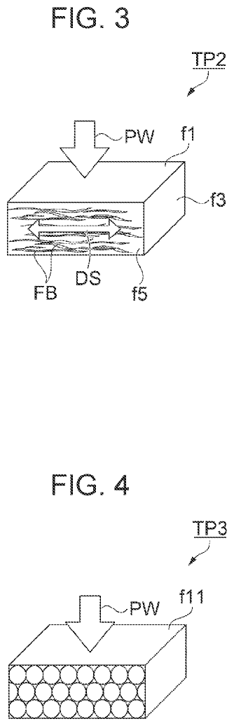

FIG. 3 shows a test piece TP2 as a comparative example used in the compression test. The test piece TP2 is produced from the sheet S. In the test piece TP2 as well, the orientation direction DS of the cellulose fibers FB is along the main surface f1. The compression force PW is applied to the test piece TP2 from the normal direction of the main surface f1 in the compression test.

FIG. 4 shows a test piece TP3 as a comparative example used in the compression test. The test piece TP3 is produced from expanded polystyrene. The compression force PW is applied to the test piece TP3 from the normal direction of the main surface f11 in the compression test.

Although not shown, a test piece TP4 is also used as a comparative example of the compression test. The test piece TP4 contains the plurality of cellulose fibers FB similarly to the test piece TP1, but the cellulose fibers FB are not oriented in the specific direction in the four directions described above in the transmission view. That is, in the test piece TP4, the plurality of cellulose fibers FB are randomly dispersed. The test piece TP4 is produced from a sheet in which the orientation direction of the cellulose fibers FB is dispersed and which has a lower density than the sheet S, by using a sheet manufacturing apparatus of the sheet S which will be described below.

The test pieces TP1, TP2, TP3, and TP4 have substantially cubic shapes having similar external dimensions. The test pieces TP1 and TP2 have a density of 0.15 g/cm³, a content of the cellulose fibers FB of 70% by mass, and a content of a binder and an additive of 30% by mass. The test piece TP4 has a density of 0.09 g/cm³, a content of the cellulose fibers FB of 67% by mass, and a content of a binder and an additive of 33% by mass.

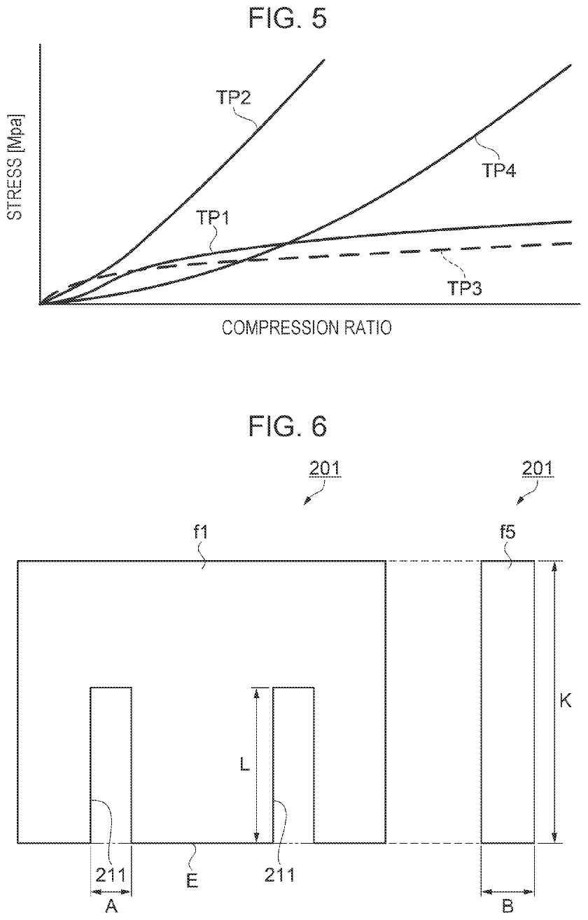

Each of the test pieces described above is subjected to the compression test conforming to JIS K 7181 to measure a relationship between a compression ratio and stress. FIG. 5 shows the results. In FIG. 5, a horizontal axis represents the compression ratio and a vertical axis represents the stress (MPa). The compression ratio is a value expressed as a percentage of a distance obtained by compressing each test piece in the direction in which the compression force PW acts by the compression force PW with respect to a thickness of each test piece in the direction in which the compression force PW acts in each test piece. The stress is a reaction force of each test piece that reacts to the compression force PW.

As shown in FIG. 5, in the test pieces TP2 and TP4, the stress is increased relatively significantly as the compression ratio is increased. The reason is that the internal density is increased when a surface pressed by the compression force PW is depressed.

On the other hand, in the test pieces TP1 and TP3, the increase in stress is relatively smaller than the increase in compression ratio. The reason is derived from the fact that the internal density is less likely to be increased even when the surface pressed by the compression force PW is depressed. That is, the test pieces TP1 and TP3 are deformed when the compression force PW, such as an impact, is applied from the outside, but have a characteristic that the stress is less likely to be increased in the process of deformation.

As a result, it is found that the test piece TP1 of the example has more excellent buffer performance than the test pieces TP2 and TP4 of the comparative examples. In addition, it is found that the test piece TP1 has the buffer performance comparable to the buffer performance of the foamed styrene test piece TP3, which is the expanded polystyrene widely recognized as the buffer member. From the above, it is shown that the sheet S shown in FIG. 1 has excellent buffer performance against the external force acting from a direction intersecting the side surfaces f3, f4, f5, and f6.

### 2. Buffer Member

The buffer member 201 produced from the sheet S will be described. The buffer material 200 includes four buffer members 201. As shown in FIG. 6, the buffer member 201 has a rectangular plate shape. Here, FIG. 6 shows a state in which the buffer member 201 on the left side in the drawing is viewed in a side view from the normal direction of the main surface f1, and shows a state in which the buffer member 201 on the right side in the drawing is viewed in a side view from the normal direction of the side surface f5. In the buffer member 201, the main surface f1 and the main surface f2 (not shown) match the same surface of the sheet S. In addition, the side surface f5 of the buffer member 201 and the side surfaces f3, f4, and f6 (not shown) are surfaces that match or are parallel to the same surface of the sheet S.

Although not shown, the buffer member 201 includes the plurality of cellulose fibers FB similarly to the sheet S. The plurality of cellulose fibers FB are oriented along the main surfaces f1 and f2 of the buffer member 201. The buffer material 200 is formed by assembling the four buffer members 201.

The four buffer members 201 have outer shapes similar to each other. Among the four buffer members 201, at least two buffer members 201 include two recess portions 211 on a side E which is one specific side. In the buffer material 200 according to the present embodiment, the four buffer members 201 have the same shape having the two recess portions 211 on the side E. The number of buffer members 201 having the two recess portions 211 on the side E is not limited to four, and may be two or three.

The two recess portions 211 are disposed to be spaced apart from an end portion of the side E toward the center of the side E. On the side E, an end portion side with respect to the recess portion 211 is a region mainly responsible for a buffer function in the buffer material 200. The space between the two recess portions 211 that are spaced from each other corresponds to a region in which an article is stored in the buffer material 200. That is, a distance between the spaced two recess portions 211 is appropriately adjusted depending on a size or a shape of the stored article.

The two recess portions 211 are notches having a substantially rectangular shape in the side view from the normal direction of the main surface f1. In each of the recess portions 211, a width A along the side E is equal to or less than a thickness B of the buffer member 201 in the direction along the normal line of the main surface f1. As a result, when the buffer material 200 is assembled, the recess portions 211 can be fitted together relatively strongly, and the buffer material 200 can be made to be less likely to come apart. The assembly of the buffer material 200 will be described below.

A depth L of each recess portion 211 from the side E is equal to or more than a length K of a side of the buffer member 201 adjacent to the side E by ½. Since the buffer material 200 is assembled by fitting the corresponding recess portions 211 of the two corresponding buffer members 201 together, when the depth L and the length K have the relationship described above, the corresponding recess portions 211 are fitted together in a relatively deep manner. As a result, the heights of the buffer materials 200 can be made uniform, and when the external force is applied from a height direction, the four buffer members 201 can evenly receive the external force.

In the buffer member 201, the thickness B, the length of the side E, the length K of the side adjacent to the side E, and the like are appropriately changed according to the size and the shape of the stored article. Although not particularly limited, for example, the thickness B is about 10 mm.

### 3. Buffer Material

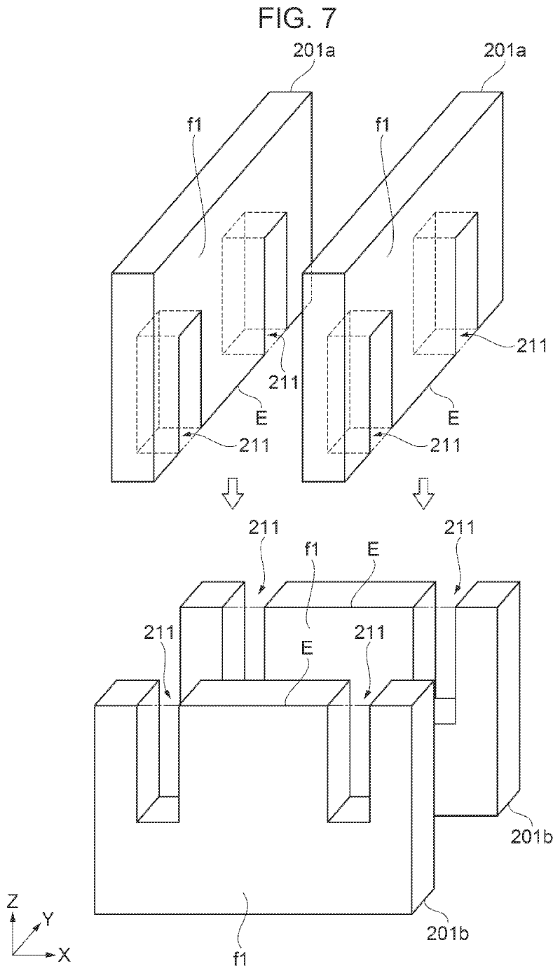

As described above, the buffer material 200 is formed by assembling the four buffer members 201. FIG. 7 schematically shows the disposition of the four buffer members 201 when the buffer material 200 is assembled. The buffer material 200 include the four buffer members 201 and has a buffer material structure described below.

As shown in FIG. 7, a pair of buffer members 201a and a pair of buffer members 201b are applied to the buffer material 200 as the four buffer members 201. Although the dispositions are different, the buffer member 201a and the buffer member 201b have the same shape.

Among the four buffer members 201, the two buffer members 201a are spaced from each other and have the respective main surfaces f1 disposed along a YZ plane which is a first plane. Among the four buffer members 201, the other two buffer members 201b are spaced from each other and have the respective main surfaces f1 disposed along an XZ plane which is a second plane orthogonal to the first plane in a plan view from a +Z direction.

In the two buffer members 201a having the main surfaces f1 disposed along the YZ plane, the side E is disposed along the Y axis and in a −Z direction that is a first direction. In the two buffer members 201b having the main surface f1 disposed along the XZ plane, the side E is disposed along the X axis and in the +Z direction that is a second direction that is a direction opposite to the first direction. The side E is orthogonal to the −Z direction that is the first direction and the +Z direction that is the second direction.

In the disposition described above, the pair of buffer members 201a and the pair of buffer members 201b are combined from above and below to form the buffer material 200. In this case, the buffer material 200 is assembled by inserting the other two buffer members 201b inserted into the recess portions 211 of the two buffer members 201a.

Specifically, in the present embodiment, since all of the four buffer members 201 have the two recess portions 211, the four buffer members 201 are assembled by fitting each recess portion 211 disposed on the side E of the buffer member 201a in the −Z direction and each recess portion 211 disposed on the side E of the buffer member 201b in the +Z direction together. When the buffer member 201 having no recess portion 211 is applied, the buffer member 201 having no recess portion 211 is fitted into the recess portion 211 of the buffer member 201 having the recess portion 211.

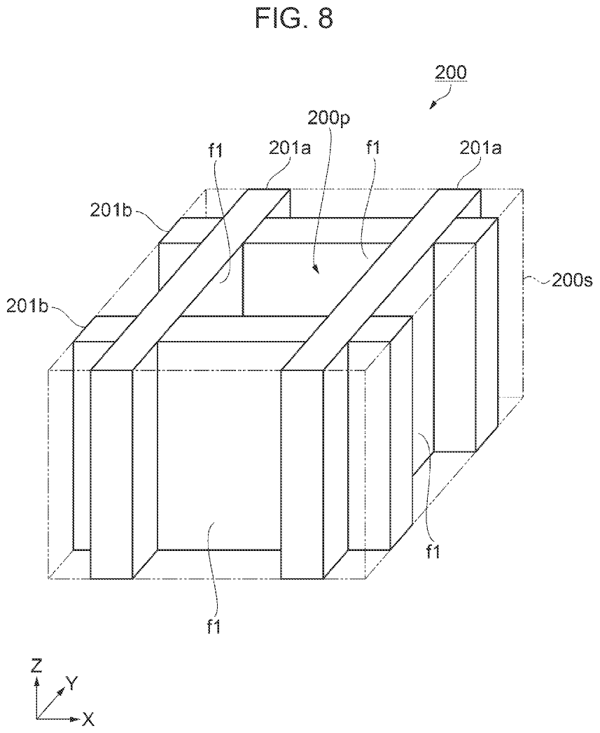

As shown in FIG. 8, when the buffer material 200 is assembled from the two buffer members 201a and the two buffer members 201b, which are the four buffer members 201, a region 200p surrounded by the two main surfaces f1 or two main surfaces f2 (not shown) is formed. The article (not shown) is stored in the region 200p in the plan view from the +Z direction.

Examples of the article stored in the buffer material 200 include fragile objects, such as pottery, porcelain, and glassware, as well as information terminal devices, such as a watch, a laptop computer, a small game machine, a smartphone, a printer, and a projector, a precision component, a model, a home appliance, and fruits and vegetables.

The buffer material 200 has a virtual external shape 200s. That is, the buffer material 200 can be regarded as a cube having the external shape 200s. Therefore, in a state in which the article is stored in the region 200p, a plurality of buffer materials 200 can be stacked and placed, or the plurality of buffer materials 200 can be packed together.

In the buffer material 200, the surface other than the main surface f1 and the main surface f2 (not shown), that is, any of the side surfaces f5 and f6 protrudes with respect to the direction along the X axis and the Y axis. Therefore, when the external force acts on the buffer material 200 from the direction substantially along the X axis and the Y axis, the external force first acts on any of the protruding side surfaces f5 and f6. In addition, in the buffer material 200, any of the side surfaces f2 and f3 protrudes with respect to the direction along the Z axis. Therefore, when the external force acts on the buffer material 200 from the direction substantially along the Z axis, the external force first acts on any of the protruding side surfaces f2 and f3. As described above, the buffer material 200 protects the article stored in the region 200p by the buffer performance against the external force acting from the direction substantially along each of XYZ axes.

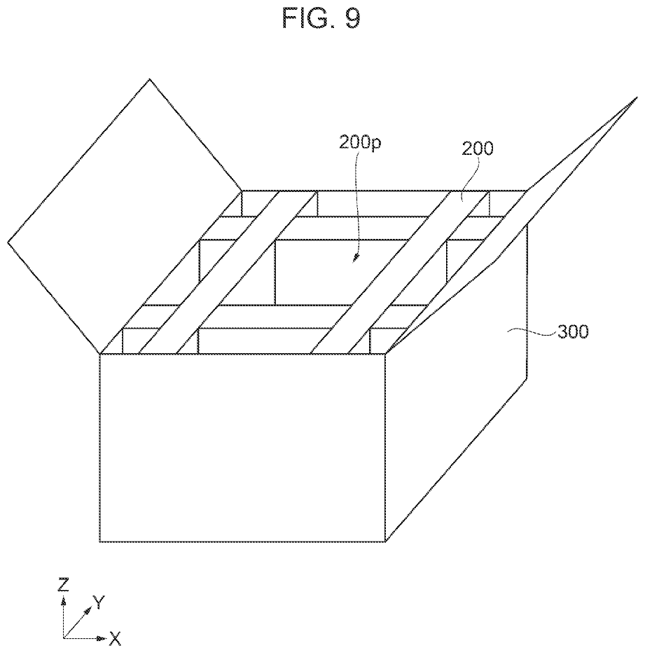

As shown in FIG. 9, the buffer material 200 may be accommodated in an outer box 300 in a detachable manner. As a result, the article stored in the region 200p of the buffer material 200 can be prevented from staining. Also, the buffer material 200 can be easily handled or stored. Materials, such as corrugated board, thick paper, and resin, are applied to the outer box 300.

When the buffer material 200 is accommodated in the outer box 300, it is preferable that the dimensions of the external shape 200s of the buffer material 200 match the internal dimensions of the outer box 300. As a result, the buffer material 200 can be steadily accommodated in the outer box 300.

### 4. Sheet Manufacturing Apparatus

A method of manufacturing the sheet S and the buffer member 201 will be described together with a configuration of a sheet manufacturing apparatus 1. In the following description of the sheet manufacturing apparatus 1, a destination of a transport direction of a raw material, the web, or the like may be referred to as downstream, and a side that goes back in the transport direction may be referred to as upstream. The method of manufacturing the sheet S and the buffer member 201 and the sheet manufacturing apparatus 1 described below are merely examples, and the present disclosure is not limited to this.

As shown in FIG. 10, the sheet manufacturing apparatus 1 includes, from an upstream part toward a downstream part, a material supply section 5, a crushing section 10, a defibration section 30, a pipe 40, a supply member 42, a forming section 100, a web transport section 70, a molding section 150, and a cutting section 160. In the following description of FIG. 10, a +Z direction may be referred to as an upward direction, and a −Z direction may be referred to as a downward direction.

The sheet manufacturing apparatus 1 includes a control section 28 that integrally controls the operation of each of the configurations. The sheet manufacturing apparatus 1 manufactures the sheet S that is a molded product having a sheet shape. A thickness of the sheet S is not particularly limited as long as the buffer member 201 produced from the sheet S exhibits the buffer performance. The thickness of the sheet S and the buffer member 201 is about 10 mm, for example. The thickness herein is a distance in the direction along the Z axis in FIG. 10.

The material supply section 5 supplies a raw material C to the crushing section 10. The material supply section 5 includes an automatic feeding mechanism, and the raw material C is continuously and automatically charged into the crushing section 10. The raw material C is a material containing the cellulose fibers FB. The material containing the cellulose fibers FB is, for example, waste paper, such as paper and corrugated board, pulp, pulp sheet, sawdust, shavings, wood, and fabric.

By defibrating such the raw material C by the defibration section 30, which will be described below, the cellulose fibers FB are obtained as defibrated materials. The cellulose fibers FB are fibers contained in plant fibers such as wood and are carbohydrates. The cellulose fiber FB is one of the main components of the sheet S manufactured by the sheet manufacturing apparatus 1. The sheet S may contain synthetic fibers, such as polypropylene, polyester, and polyurethane, in addition to the cellulose fibers FB. From the viewpoint of reducing the environmental load, it is preferable to use fibers derived from natural products, such as the cellulose fibers FB. Hereinafter, the cellulose fibers FB and the like applied to the sheet S are collectively and simply referred to as fibers.

The crushing section 10 shreds the raw material C supplied from the material supply section 5 in the air, such as the atmosphere. The crushing section 10 has a crushing blade 11. The crushing section 10 is, for example, a shredder or a cutter mill. The raw material C is shredded by the crushing blade 11 into fragments. A planar shape of the fragment is, for example, several mm square or irregular. The fragments are collected in a fixed-quantity material supply section 50.

The fixed-quantity material supply section 50 weighs the fragments and supplies the fragments to a hopper 12 in a fixed quantity. The fixed-quantity material supply section 50 is, for example, a vibration feeder. The fragments supplied to the hopper 12 are transported to an introduction port 31 of the defibration section 30 through the pipe 20.

The defibration section 30 includes an introduction port 31, a discharge port 32, a stator 33, and a rotor 34. The defibration section 30 defibrates the fragments of the raw material C by a dry method to produce the fibers. The fragments of the raw material C are introduced into an inside of the defibration section 30 through the introduction port 31 by a suction airflow of an air blowing section 41, which will be described below. In the present specification, the dry method means that it is carried out in the air, such as the atmosphere, not in the liquid.

The stator 33 and the rotor 34 are disposed inside the defibration section 30. The stator 33 has an inner side surface having a substantially cylindrical shape. The rotor 34 rotates along the inner side surface of the stator 33. The fragments of the raw material C are interposed between the stator 33 and the rotor 34, and are defibrated by a shearing force generated between the stator 33 and the rotor 34 to be the fibers. The fibers are sucked into the pipe 40 from the discharge port 32 of the defibration section 30 by the suction airflow.

It is preferable that the fibers produced by the defibration have a fiber length of 1.0 mm or more. Accordingly, since the fibers are not excessively shortened, a mechanical strength of the sheet S is improved. The fiber length is obtained by a method conforming to ISO 16065-2: 2007.

The pipe 40 communicates with the inside of the defibration section 30 and an inside of the supply member 42. The pipe 40 is provided with a mixing section 60 and the air blowing section 41. The mixing section 60 is disposed upstream of the air blowing section 41. The pipe 40 supplies a mixture, which is a material containing the fibers and will be described below, to the supply member 42 by a downstream airflow generated by the air blowing section 41.

The mixing section 60 includes hoppers 13 and 14, supply pipes 61 and 62, and valves 65 and 66. The mixing section 60 mixes a binder and an additive with the material, such as the fibers, transported in the air of the pipe 40. As a result, the mixture is produced.

The hopper 13 supplies the binder into the pipe 40. The hopper 13 communicates with an inside of the pipe 40 through the supply pipe 61. The valve 65 is disposed between the hopper 13 and the pipe 40 in the supply pipe 61. The valve 65 adjusts the weight of the binder supplied from the hopper 13 to the pipe 40. The valve 65 adjusts a mixing ratio between the fibers and the binder. The binder may be supplied as a powder, or may be melted and supplied.

The binder binds the fibers together. As the binder, a resin having thermal plasticity or thermosetting property is used. Examples of the resin include resins derived from natural products, such as shellac, pine resin, dammar, polylactic acid, polybutylene succinate derived from a plant, polyethylene derived from a plant, and PHBH (registered trademark) (poly(3-hydroxybutyrate-co-3-hydroxyhexanoate)) manufactured by KANEKA CORPORATION, and known synthetic resins. As the binder, one of these types may be used alone, or in combination of two or more types. From the viewpoint of reducing the environmental load, it is preferable that the binder is a resin derived from natural products.

The hopper 14 supplies the additive into the pipe 40. The hopper 14 communicates with the inside of the pipe 40 through the supply pipe 62. The valve 66 is disposed between the hopper 14 and the pipe 40 in the supply pipe 62. The valve 66 adjusts the weight of the additive supplied from the hopper 14 to the pipe 40. The valve 66 adjusts a mixing ratio of the additive to the fibers and the binder.

Examples of the additive include a colorant, a flame retardant, an antioxidant, an ultraviolet absorber, an aggregation inhibitor, an antibacterial agent, an antifungal agent, a wax, and a mold release agent. The additive is not an essential component in the sheet S, and the hopper 14, the supply pipe 62, or the like may be omitted. In addition, the additive may be mixed with the binder in advance and supplied from the hopper 13.

The air blowing section 41 is an airflow generator, such as a blower. The air blowing section 41 transports the material containing the fibers to the downstream pipe 40 by the downstream airflow. In addition to the airflow, the air blowing section 41 also generates the suction airflow for sucking the fibers from the defibration section 30. A volumetric flow rate of the airflow going downstream of the air blowing section 41 is controlled by the control section 28. The volumetric flow rate can be changed, for example, by a rotation speed of an air blowing fan provided in the air blowing section 41.

The fibers, the binder, and the like are mixed while being transported to the supply member 42 in the pipe 40 to form the mixture. The mixture is introduced into the supply member 42 that couples a downstream end of the pipe 40 to the forming section 100.

The supply member 42 rectifies a flow of the mixture supplied from the pipe 40 and guides the mixture to the forming section 100. The supply member 42 is coupled to a dispersion section 101 of the forming section 100. Specifically, the inside of the supply member 42 communicates with an inside of a drum section 101b of the dispersion section 101. As a result, the mixture flows into the drum section 101b from the supply member 42.

The forming section 100 forms a web W by accumulating the mixture containing the fibers, the binder, and the like in the air. The web W has a wide band shape in the direction along the Y axis. The forming section 100 includes the dispersion section 101 and an accumulation section 102. The dispersion section 101 is disposed inside the accumulation section 102. The inside of the dispersion section 101 communicates with the pipe 40 through the supply member 42. The web transport section 70 is disposed below the accumulation section 102.

The dispersion section 101 includes a rotating member 101a and a drum section 101b for accommodating the rotating member 101a. The forming section 100 takes the mixture from the supply member 42 into the inside of the dispersion section 101, and accumulates the mixture on a mesh belt 122 of the web transport section 70 by a dry method.

Specifically, the rotating member 101a is a member including a + shaped blade in a side view from a −Y direction. The rotating member 101a rotates around a rotation axis along the Y axis as a rotation center by driving a motor or the like.

The drum section 101b is a member having a substantially columnar shape, and a height direction of the substantially columnar shape is along the Y axis. A lower part of the drum section 101b is formed of a metal mesh. The mesh of the metal mesh allows the fibers, the binder, or the like contained in the mixture to pass through.

The mixture (not shown) is introduced into the drum section 101b and unraveled by the rotating member 101a that rotates. A plurality of fibers in the mixture are released from an entangled state, separated into a single body, and pass through the mesh of the drum section 101b. As a result, the dispersion section 101 disperses the fibers, the binder, and the like contained in the mixture into the air in the accumulation section 102.

The accumulation section 102 is a member having a substantial box shape. The accumulation section 102 is disposed below the dispersion section 101. In the accumulation section 102, the supply member 42 is disposed above an upper surface, and the dispersion section 101 is disposed on an inner side of the upper surface. A region corresponding to a bottom surface of the accumulation section 102 is opened downward. The dispersion section 101 is inside the accumulation section 102 and faces an upper surface of the mesh belt 122 of the web transport section 70. The accumulation section 102 is formed of a resin or a metal, for example.

The mixture is discharged from the inside of the dispersion section 101 into the air inside the accumulation section 102, and is guided above the mesh belt 122 by gravity and a suction force of a suction mechanism 110. Therefore, the mixture is accumulated on the upper surface of the mesh belt 122 through a first base material N1, which will be described below. That is, the accumulation section 102 accumulates the mixture containing the dispersed fibers to form the web W.

With the configuration described above, in the web W, the plurality of fibers are oriented along the XY plane. That is, a base of the orientation state of the sheet S is formed in which the plurality of fibers are along the main surfaces f1 and f2.

The web transport section 70 includes the mesh belt 122 and the suction mechanism 110. The mesh belt 122 is an endless belt and is stretched by four stretch rollers 121.

The mesh belt 122 has a strength capable of holding the web W and the like without interfering with the suction by the suction mechanism 110. The mesh belt 122 is formed of a resin or a metal, for example. A hole diameter of the mesh included in the mesh belt 122 is not particularly limited, but is desirably 60 μm or more and 125 μm or less.

At least one of the four stretch rollers 121 is rotationally driven by a motor (not shown). The upper surface of the mesh belt 122 is moved downstream due to the rotation of the stretch roller 121. Stated another way, the mesh belt 122 moves rotationally clockwise in FIG. 10. By the mesh belt 122 moving rotationally, the first base material N1 and the web W, which will be described below, are transported downstream.

A base material supply section 71 is disposed in the −X direction of the web transport section 70. The base material supply section 71 rotatably supports the first base material N1 having a roll shape. The first base material N1 is continuously supplied from the base material supply section 71 to the upper surface of the mesh belt 122.

The first base material N1 interposes the web W with a second base material N2, which will be described below. For example, for the first base material N1 and the second base material N2, a woven fabric or a non-woven fabric is applied. It is preferable that the first base material N1 has a configuration that does not interfere with the suction of the suction mechanism 110. For example, for the first base material N1 and the second base material N2, a polyester long fiber nonwoven fabric manufactured by a spunbond method is applied.

The sheet S is formed by laminating the first base material N1, the web W, and the second base material N2, so that the mechanical strength is improved. In the sheet S, the first base material N1 and the second base material N2 are not essential configurations, and any one or both thereof may be omitted.

When the base material supply section 71 supplies the first base material N1 to the mesh belt 122, the first base material N1 is transported on the mesh belt 122 in the +X direction. In the first base material N1 while being transported, the mixture is fallen from the accumulation section 102 and accumulated on the upper surface. As a result, the web W is continuously formed on the upper surface of the first base material N1. The mesh belt 122 transports the web W downstream together with the first base material N1.

The suction mechanism 110 is disposed below the dispersion section 101. The suction mechanism 110 promotes the accumulation of the mixture on the mesh belt 122. The suction mechanism 110 sucks the air into the accumulation section 102 through a plurality of holes included in the mesh belt 122 and the first base material N1. The plurality of holes in the mesh belt 122 and the first base material N1 allow the air to pass through, and make it difficult for the fibers, the binder, or the like contained in the mixture to pass through. The mixture discharged from the dispersion section 101 to an inner side of the accumulation section 102 is sucked downward together with the air. A known suction device, such as a blower, is adopted for the suction mechanism 110.

As a result, the mixture in the accumulation section 102 is accumulated on the upper surface of the first base material N1 by the suction force of the suction mechanism 110 in addition to the gravity, to form the web W. The web W contains a relatively large amount of the air and is soft and swollen. By the mesh belt 122, the web W is transported downstream together with the first base material N1.

A humidifying section 139 is provided at a position facing the web W above the mesh belt 122 in the +X direction of the accumulation section 102. The humidifying section 139 sprays water onto the web W on the mesh belt 122 to humidify the web W. As a result, scattering of the fibers, the binder, or the like contained in the web W can be suppressed. In addition, the water used for the humidification may be impregnated with a water-soluble additive or the like, and the web W may be impregnated with the additive in parallel with the humidification.

A dancer roller 141 is disposed downstream of the web transport section 70. The web W is peeled from the most downstream stretch roller 121, and then pulled into the dancer roller 141. The dancer roller 141 secures a processing time on the downstream part. Specifically, molding in the molding section 150 is a batch process. Therefore, the dancer roller 141 is moved up and down with respect to the web W continuously transported from the accumulation section 102, and a time for reaching the molding section 150 is delayed.

The base material supply section 72 is disposed downstream of the dancer roller 141 and upstream of the molding section 150. The base material supply section 72 rotatably supports the second base material N2 having a roll shape. The second base material N2 is continuously supplied from the base material supply section 72 to the upper surface of the web W. As a result, the web W is fed out to the molding section 150 in a state of being interposed between the lower first base material N1 and the upper second base material N2.

The molding section 150 is a heat pressing device, and includes an upper substrate 152 and a lower substrate 151. The molding section 150 molds the first base material N1, the web W, and the second base material N2 into the sheet S having a continuous paper shape. The upper substrate 152 and the lower substrate 151 are pressurized with the web W interposed therebetween, and are heated by a built-in heater.

The web W is compressed from above and below by the pressurization to be increased in the density, and the binder is melted by the heating and spreads wet between the fibers. When the heating ends in this state and the binder is solidified, the fibers are bound to each other by the binder. As a result, the sheet S having a continuous paper shape, which is composed of three layers of the first base material N1, the web W, and the second base material N2, is molded. In this case, the sheet S is formed while the orientation state of the sheet S is fixed. The sheet S having a continuous paper shape proceeds to the downstream cutting section 160.

In the molding section 150, instead of the heat pressing device, a heating roller and a pressurization roller may be used for continuous molding. In this case, the dancer roller 141 may be omitted.

The cutting section 160 cuts the sheet S from a continuous paper shape to a single paper shape. Although not shown, the cutting section 160 includes a vertical blade and a horizontal blade. The vertical blade and the horizontal blade are rotary cutters, for example. In addition, an ultrasound cutter or the like may be used instead of the rotary cutter.

The vertical blade cuts the sheet S having a continuous paper shape in a direction along the traveling direction. The horizontal blade cuts the sheet S having a continuous paper shape in a direction intersecting the traveling direction. The sheet S is processed into a substantially rectangular single paper shape and accommodated in a tray 170. In this way, the sheet S is manufactured.

The sheet manufacturing apparatus 1 may include a processing unit (not shown) downstream of the cutting section 160 or the tray 170. The processing unit forms the recess portion 211 in the sheet S having the single paper shape. For example, a wheel cutter, a partial cutter, a Thomson type (Vic type), and the like are applied to the processing unit. The buffer member 201 may be produced from the sheet S by another apparatus.

According to the present embodiment, it is possible to obtain the following effects.

The buffer material 200 that is easily assembled with a simple configuration can be obtained. Specifically, since the buffer material 200 is formed by assembling the four buffer members 201 by using the recess portion 211, the labor required for assembly is reduced as compared with the related art. In addition, since the buffer material 200 includes the four buffer members 201, the number of components is smaller than that in the related art, and the configuration is simple. Accordingly, it is possible to provide the buffer material 200 and the buffer material structure which are easily assembled with a simple configuration.

Since the four buffer members 201 have the same shape, the type of component is one type and can be used for common use. In addition, since the assembly is made by fitting the recess portions 211 together, misalignment is unlikely to occur, and the buffer material 200 can be steadily assembled.

What is claimed is:

1. A buffer material comprising:
four buffer members containing cellulose fibers and having rectangular plate shapes similar to each other, wherein
the cellulose fibers are oriented along a main surface of the buffer member,
at least two buffer members among the four buffer members have two recess portions on one specific side,
the buffer material is assembled by inserting the other buffer members into the recess portions of the buffer members,
two buffer members among the four buffer members are spaced apart from each other and each have the main surfaces disposed along a first plane, and the other two buffer members are spaced apart from each other and each have the main surfaces disposed along a second plane orthogonal to the first plane in a plan view, and
an article is stored in a region surrounded by the four buffer members in the plan view.

2. The buffer material according to claim 1, wherein
the four buffer members have the same shape having the two recess portions on the one specific side,
the one specific side is disposed in a first direction in the two buffer members having the main surfaces disposed along the first plane,
the one specific side is disposed in a second direction, which is a direction opposite to the first direction, in the two buffer members having the main surfaces disposed along the second plane, and
the four buffer members are assembled by fitting the recess portion disposed on the one specific side in the first direction and the recess portion disposed on the one specific side in the second direction together.

3. The buffer material according to claim 2, wherein
in the recess portion, a width A along the one specific side is equal to or less than a thickness B of the buffer member.

4. The buffer material according to claim 3, wherein
a depth L of the recess portion is equal to or more than a length K of a side of the buffer member adjacent to the one specific side by ½.

5. The buffer material according to claim 1, wherein
the buffer material is accommodated in an outer box in a detachable manner.

6. The buffer material according to claim 5, wherein
external dimensions match internal dimensions of the outer box.

7. A buffer material structure comprising:
four buffer members containing cellulose fibers and having rectangular plate shapes similar to each other,
wherein the cellulose fibers are oriented along a main surface of the buffer member,
the four buffer members have the same shape having two recess portions on one specific side,
two buffer members among the four buffer members are spaced apart from each other and each have the main surface disposed along a first plane, and the other two buffer members are spaced apart from each other and each have the main surface disposed along a second plane orthogonal to the first plane in a plan view,
the one specific side is disposed in a first direction in the two buffer members having the main surfaces disposed along the first plane,
the one specific side is disposed in a second direction, which is a direction opposite to the first direction, in the two buffer members having the main surfaces disposed along the second plane,
the four buffer members are assembled by fitting the recess portion disposed on the one specific side in the first direction and the recess portion disposed on the one specific side in the second direction together, and
an article is stored in a region surrounded by the four buffer members in the plan view.
